(19) United States
(12) Patent Application Publication
(10) Pub. No.: US 2015/0356056 A1
(43) Pub. Date: Dec. 10, 2015

(54) METHODS AND SYSTEMS FOR CALCULATING JOINT STATISTICAL INFORMATION

(71) Applicant: The MathWorks, Inc., Natick, MA (US)

(72) Inventor: Andrew Matteson, Cambridge, MA (US)

(73) Assignee: The MathWorks, Inc.

(21) Appl. No.: 14/733,477

(22) Filed: Jun. 8, 2015

Related U.S. Application Data
(60) Provisional application No. 62/009,850, filed on Jun. 9, 2014.

(51) Int. Cl. G06F 17/18; G06F 17/16

(52) U.S. Cl. CPC G06F 17/18; G06F 17/16

(57) ABSTRACT

Computer-implemented methods and systems are provided for calculating statistical information. A computing system may be configured to call a linear algebra subroutine adapted to efficiently perform matrix multiplication, providing as arguments a first matrix and a second matrix, consistent with disclosed embodiments. The first matrix may include first elements corresponding to binned values of first measurements associated with a first observation. The second matrix may include second elements corresponding to binned values of second measurements associated with a set of second observations. The computing system may be configured to receive a joint value matrix estimating the joint probabilities for the binned measurements from the linear algebra subroutine. The computing system may determine a structure of the set of second observations based on the joint value matrix. In certain aspects, the computing system may determine the mutual information between the first observation and the set of second observations.

### CLAIM OF PRIORITY

This application claims the benefit of U.S. Provisional Application No. 62/009,850, filed Jun. 9, 2014, which is incorporated here by reference in its entirety to provide continuity of disclosure.

### SUMMARY

The disclosed embodiments may include, for example, computer-implemented methods and systems for determining joint statistical information. These methods and systems may calculate the joint statistical information as the product of two discretized matrices. One of the discretized matrices may be pre-calculated and cached. This pre-calculated matrix may be dimensioned to permit the simultaneous parallel computation of joint statistical information for multiple observations. These methods and systems may call linear algebra subroutines to efficiently perform this simultaneous parallel computation of joint statistical information.

The disclosed embodiments may include, for example, a first computer-implemented method for calculating joint statistical information. The method may include calling a linear algebra subroutine adapted to efficiently perform matrix multiplication. The subroutine may be provided arguments including a first matrix and a second matrix. The first matrix may correspond to a first observation. The first matrix may include first elements, such as binned values of first measurements associated with the first observation. The rows of these first elements may correspond to first bins and the columns of the first elements may correspond to first measurements. The second matrix may correspond to a set of second observations. The second matrix may include second elements, such as binned values of second measurements associated with the second observations. The rows of these second elements may correspond to second bins and the columns of the second elements may correspond to second measurements. The method may include receiving a joint value matrix from the linear algebra subroutine. This joint value matrix may include a third matrix with third elements including estimated joint probabilities for first bins and second bins. The rows of the third elements may correspond to first bins and the columns of the third elements may correspond to second bins and second observations. The method may include outputting statistical information based on the joint value matrix to determine a structure for the plurality of second observations. In certain embodiments, the method may further include determining a fourth vector from the joint value statistic. The elements of the fourth vector may include components of joint Shannon entropies associated with the first bins and the second bins. In certain aspects, the method may determine a fifth vector from the fourth vector. The elements of the fifth vector may include the mutual information between the first observation and the second observations.

The disclosed embodiments may include, as an additional example, a first computer-implemented method for calculating joint statistical information. The method may include receiving an observation vector corresponding to a first observation. The observation vector may include first elements comprising first measurements associated with the first observation. The method may include determining a discretized observation vector based on the observation vector. The discretized observation vector may include second elements. The values of the second elements may include the contributions of first measurements to first bins. The method may include receiving a cached observation matrix associated with a plurality of second observations. The cached observation matrix may include third elements. The values of the third elements may include the contribution of second measurements associated with the second observations to second bins. The method may include determining a joint value matrix based on the discretized observations matrix and the cached observation matrix, the joint value matrix including fourth elements comprising estimated joint probabilities for first bins and second bins. The method may include determining a structure of the plurality of second observations based on the joint value matrix. In some embodiments, the joint value matrix may include the product of the discretized observation vector and the cached observation matrix. In certain embodiments this product may be calculated according to a linear algebra subroutine adapted to efficiently perform matrix multiplication. In some embodiments, the contribution of first measurements to first bins is determined according to an indicator function. In other embodiments the contribution of first measurements to first bins is determined according to a membership function. In certain embodiments, the membership function is a b-splines function.

The disclosed embodiments may include, as an additional example, a non-transitory computer-readable medium comprising instructions that, when executed by at least one processor, cause the at least one processor to perform certain operations. These operations may include receiving an observation vector corresponding to a first observation. This observation vector may include first elements comprising first measurements associated with the first observation. These operations may include determining a discretized observation vector based on the observation vector. This discretized observation vector may include second elements comprising the contribution of first measurements to first bins. These operations may include receiving a cached observation matrix associated with a plurality of second observations. This cached observation matrix may include third elements comprising the contribution of second measurements associated with the second observations to second bins. These operations may include determining a joint value matrix comprising the product of the discretized observations matrix and the cached observation matrix. This joint value matrix may include fourth elements comprising estimated joint probabilities for first bins and second bins. These operations may include determining a statistical output vector based on the joint value matrix. This statistical output vector may include fifth elements based on estimated joint probabilities for first bins and second bins. This vector may have columns corresponding to second observations. These operations may include outputting the statistical output vector to determine a structure of the plurality of second observations.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 depicts a block diagram of an exemplary computing system.

FIG. 2 depicts a block diagram of an exemplary memory component.

FIGS. 3A-3H depict data structures associated with an exemplary method for determining joint statistical information

FIG. 4 depicts a flowchart of an exemplary method for pre-calculating a cached observation matrix.

FIG. 5 depicts a flowchart of an exemplary method for determining joint statistical information.

FIG. 6 depicts a flowchart of an exemplary method for determining an accumulation vector.

### DETAILED DESCRIPTION

Techniques in bioinformatics, signal processing, machine learning, and related applications often require the estimation of joint statistics between random variables. For example, these techniques may evaluate the mutual information between random variables. Mutual information, a generalization of correlation, is a non-negative measure of the independence of random variables. Unlike correlation, mutual information can capture non-linear dependencies between variables. In some instances, mutual information can be a more robust statistic than correlation.

Calculation of joint statistics for continuous variables, however, may require the evaluation of a double integral. A double summation may be used to approximate such double integrals. Such methods, as implemented, may require computation of multiple nested loops. For large datasets, such as those encountered in bioinformatics, signal processing, and machine learning, evaluation of such loops may be impractical. Additionally, certain methods, such as attractor metagene clustering, may involve multiple iterations, each iteration requiring the calculation of joint statistical information, such as the mutual information between two random variables.

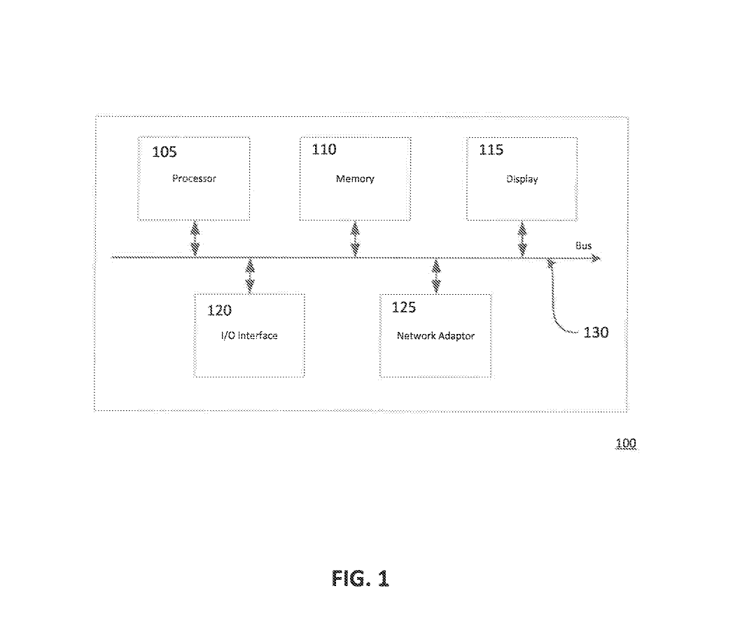

In various embodiments, the disclosed methods or systems are implemented via one or more computing devices. FIG. 1 illustrates a block diagram of an exemplary computing system 100 according to some embodiments. According to some embodiments, system 100 includes a processor 105, memory 110, display 115, I/O interface(s) 120, and network adapter 125. These units may communicate with each other via bus 130 and/or wirelessly, or a combination thereof. The components shown in FIG. 1 may reside in a single device or multiple devices.

In various embodiments, processor 105 may be one or more microprocessors or central processor units (CPUs) performing processing operations. Memory 110 may include one or more computer hard disks, random access memory (RAM), EEPROM, flash memory, removable storage, or remote computer storage. In various embodiments, memory 110 may store data and computer program code, including various software programs executed by processor 105. Display 115 may be any device which provides a visual output, for example, a computer monitor, an LCD screen, etc. I/O interfaces 120 may include, for example, a keyboard, a mouse, an audio input device, a touch screen, or an infrared input interface. Network adapter 125 may enable device 100 to exchange information with external networks. In various embodiments, network adapter 125 may include a wireless wide area network (WWAN) adapter, or a local area network (LAN) adapter.

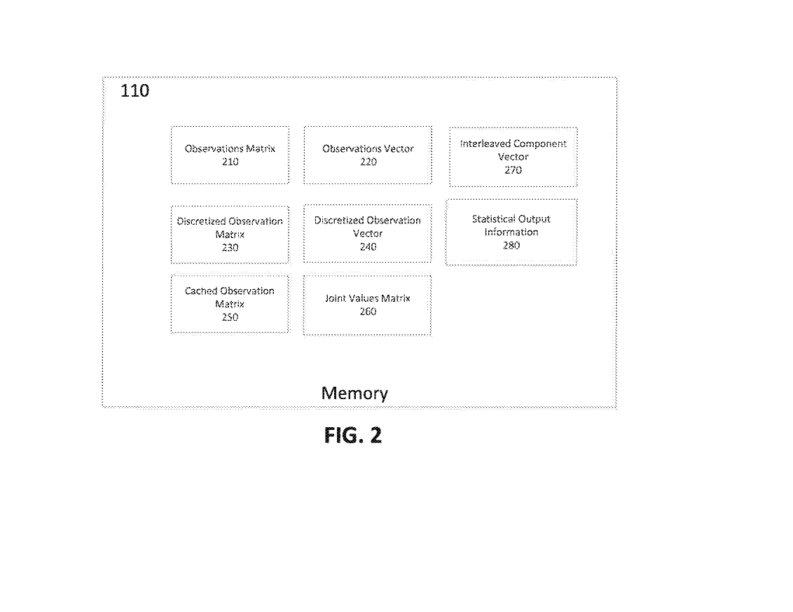

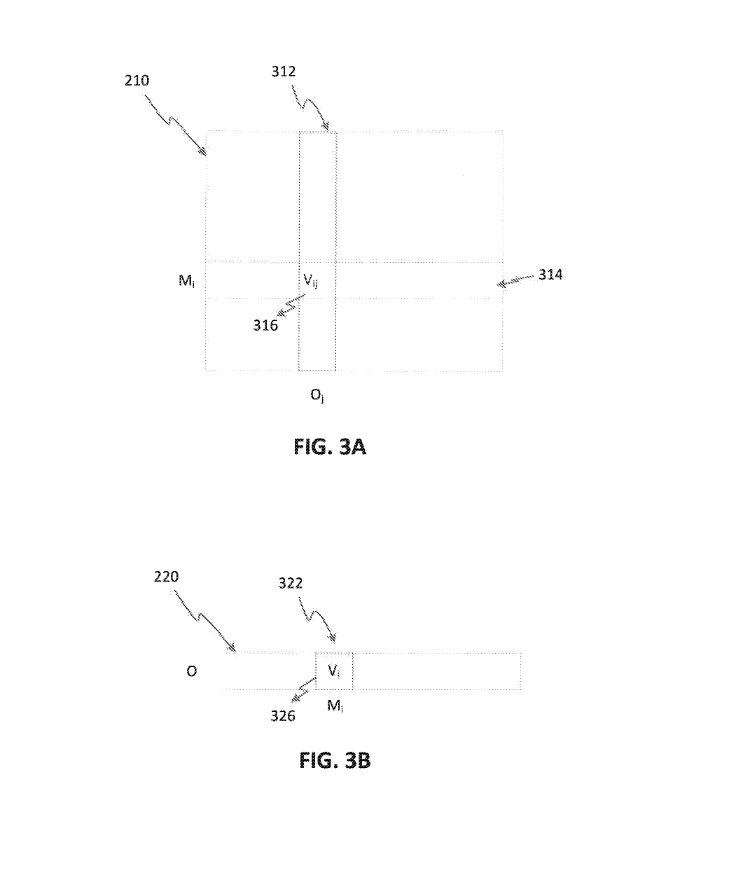

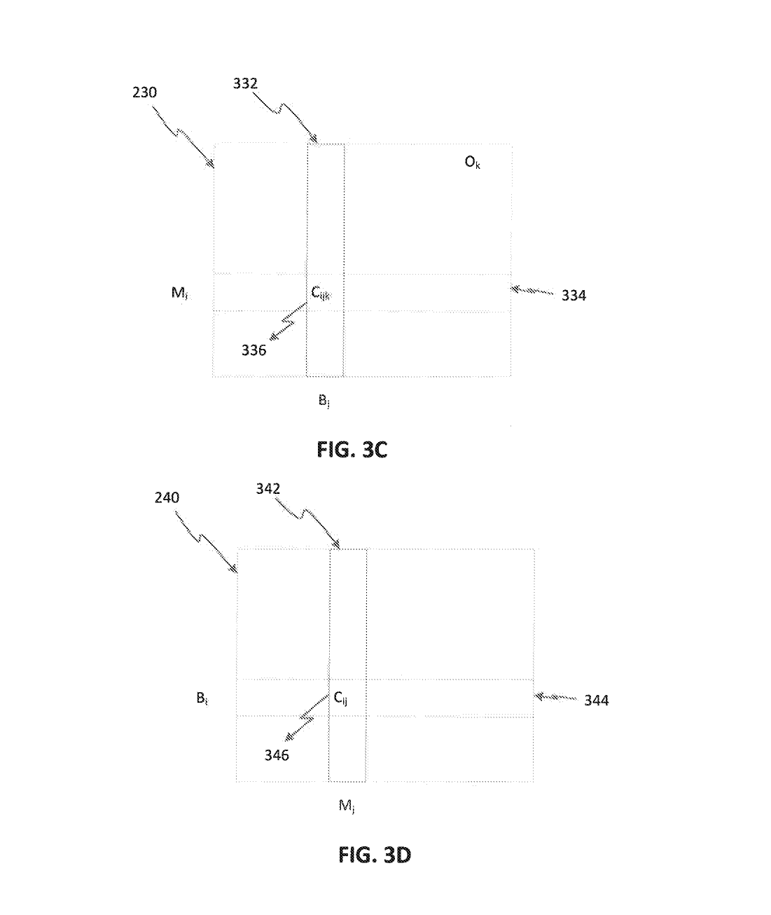

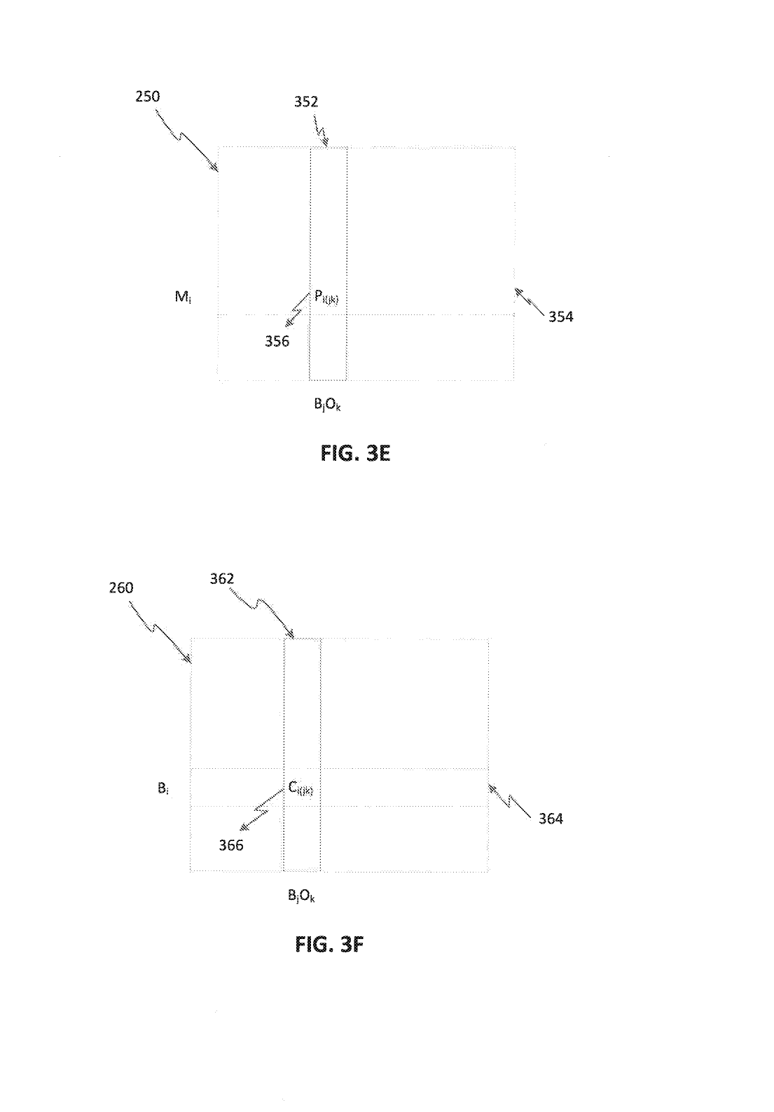

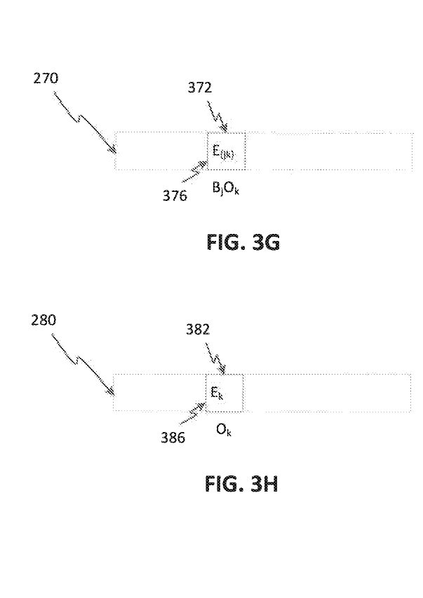

FIG. 2 depicts a block diagram of an exemplary memory component consistent with disclosed embodiments. Computing system 100 may be configured to store in memory 110 a data structure including an observations matrix 210 in some embodiments. In various aspects, computing system 100 may be configured to receive observations matrix 210 through I/O interface 120, or through network adaptor 125. In certain aspects, computing system 100 may be configured to derive observations matrix 210 from data received through I/O interface 120, or through network adaptor 125. As shown in FIG. 3A, observations matrix 210 may have columns corresponding to observations, such as column 312 corresponding to observation Oⱼ, and rows corresponding to measurements, such as row 314 corresponding to measurement Mᵢ. These measurements may be modeled as continuous-valued random variables. Observations matrix 210 may have elements, such as element 316 corresponding to observation Oⱼ and measurement Mᵢ and having value Vᵢⱼ in certain embodiments. In some embodiments, for example, observations may include genes, measurements may include certain gene expressions, and elements may include values for the certain gene expressions.

Referring now to FIG. 2, computing system 100 may be configured to store in memory 110 a data structure including an observation vector 220 in some embodiments. In various aspects, computing system 100 may be configured to receive observation vector 220 through I/O interface 120, or through network adaptor 125. In certain aspects, computing system 100 may be configured to derive observation vector 220 from data received through I/O interface 120, or through network adaptor 125. As shown in FIG. 3B, in a first aspect, observation vector 220 may correspond to an observation, such as observation O, and have rows corresponding to measurements, such as row 322 corresponding to measurement Mᵢ. Observation vector 220 may have elements, such as element 326 corresponding to observation O and measurement Mᵢ and having value Vᵢ in certain embodiments. In a second aspect, observation vector 220 may correspond to data and have rows corresponding to calculated values. These measurements and values may be modeled as continuous-valued random variables. As a non-limiting example, observation vector 220 may correspond to a metagene and the calculated values may be weighted sums of gene expression.

Referring again to FIG. 2, computing system 100 may be configured to store in memory 110 a data structure including a discretized observations matrix 230 in some embodiments. Computing system 100 may construct discretized observations matrix 230 from observations matrix 210 using processor 105 in some embodiments. In various aspects, computing system 100 may be configured to receive discretized observations matrix 230 through I/O interface 120, or through network adaptor 125. In certain aspects, computing system 100 may be configured to derive discretized observations matrix 230 from data received through I/O interface 120, or through network adaptor 125. Discretized observations matrix 230 may be at least a three dimensional matrix in certain aspects. As shown in FIG. 3C, discretized observations matrix 230 may have a first dimension corresponding to measurements, such as first dimension 334 corresponding to measurement Mᵢ. Discretized observations matrix 230 may have a second dimension corresponding to bins, such as second dimension 332 corresponding to bin Bᵢ. These bins may correspond to value intervals Aᵢ. Discretized observations matrix 230 may have a third dimension (not shown) corresponding to observations, such as observation Oₖ. Discretized observations matrix 230 may have elements, such as element 336 corresponding to measurement Mᵢ, bin Bⱼ, and observation Oₖ. According to envisioned embodiments, computing system 100 may be configured to use indicator or membership functions to determine the contribution of Mᵢ to the elements of discretized observations matrix 230, such as element 336. For example, indicator functions may assign a value of zero or one to element 336 according to the following relation:

$${1}_{{A}_{i}} ( {M}_{i} ) := \{ \begin{matrix}1 & if {M}_{i} ∈ {A}_{i} \\ 0 & otherwise\end{matrix}$$

As an additional example, membership functions may assign a value between zero and one to element 336 based on Mᵢ and Aᵢ. The membership function may be a basis spline function and the contribution may be calculated.

Referring again to FIG. 2, computing system 100 may be configured to store in memory 110 a data structure including a discretized observation vector 240 in some embodiments. Computing system 100, for example, may construct discretized observation vector 240 from observation vector 220. In various aspects, computing system 100 may be configured to receive discretized observation vector 240 through I/O interface 120, or through network adaptor 125. In certain aspects, computing system 100 may be configured to derive discretized observation vector 240 from data received through I/O interface 120, or through network adaptor 125. As shown in FIG. 3D, discretized observation vector 240 may be at least a two dimensional matrix in certain aspects. Discretized observation vector 240 may have rows corresponding to bins, such as row 344 corresponding to bin Bᵢ and columns corresponding to measurements, such as column 342 corresponding to measurement Mⱼ. Discretized observation vector 240 may have elements such as element 346 corresponding to bin Bᵢ and measurement Mⱼ. As described above with reference to discretized observations matrix 230, according to envisioned embodiments, computing system 100 may be configured to use indicator or membership functions to determine the value of elements of discretized observation vector 240, such as element 346.

Referring again to FIG. 2, in some embodiments, computing system 100 may be configured to store in memory 110 a data structure including a cached observation matrix 250. Computing system 100 may construct cached observation matrix 250 from discretized observations matrix 230 using processor 105 in some embodiments. In various aspects, computing system 100 may be configured to receive cached observation matrix 250 through I/O interface 120, or through network adaptor 125. In certain aspects, computing system 100 may be configured to derive cached observation matrix 250 from data received through I/O interface 120, or through network adaptor 125. As shown in FIG. 3E, cached observation matrix 250 may be at least a two dimensional matrix in an embodiment. Cached observation matrix 250 may have rows corresponding to measurements, such as row 354 corresponding to measurement Mᵢ. Cached observation matrix 250 may have columns corresponding to combinations of bins and observations, such as column 352 corresponding to the combination of bin Bⱼ and observation Oₖ. In such embodiments, cached observation matrix 250 may have a number of columns equal to the number of bins times the number of observations. Cached observations matrix 250 may include elements, such as element 356 corresponding to measurement Mᵢ and the combination of bin Bᵢ and observation Oₖ. As described above with reference to discretized observations matrix 230, according to envisioned embodiments, computing system 100 may be configured to use indicator or membership functions to determine the value of elements of cached observation vector 250, such as element 356.

Referring again to FIG. 2, computing system 100 may be configured to store in memory 110 using processor 105 a data structure including a joint values matrix 260 in some embodiments. Computing system 100 may be configured to calculate joint values matrix 260 from cached observation matrix 250 and discretized observation vector 240 using processor 105 in some embodiments. Joint values matrix 260 may be the matrix product of discretized observation vector 240 and cached observation matrix 250 in certain aspects. In various aspects, computing system 100 may be configured to receive joint values matrix 260 through I/O interface 120, or through network adaptor 125. In certain aspects, computing system 100 may be configured to derive joint values matrix 260 from data received through I/O interface 120, or through network adaptor 125. As shown in FIG. 3F, joint values matrix 260 may have at least two dimensions in certain embodiments. Joint values matrix 260 may have rows corresponding to bins, such as row 364 corresponding to bin Bᵢ. Joint values matrix 260 may have columns corresponding to bins and observations, such as column 362 corresponding to the combination of bin Bⱼ and observation Oₖ. In such embodiments, joint values matrix 260 may have a number of columns equal to the number of bins times the number of observations. Joint values matrix 260 may include elements, such as element 366 corresponding to bin Bᵢ and the combination of bin Bⱼ and observation Oₖ. The elements of joint values matrix 260 may contain estimates of joint probabilities consistent with disclosed embodiments. For example, element 366 may contain estimate Cᵢ₍ⱼₖ₎, which estimates the probability a first event and a second event both occur. The first event may be a measurement of the observation corresponding to observation vector 220 falling within the value interval corresponding to bin Bᵢ. The second event may be a measurement of the observation Oₖ in observations matrix 210 falling within the value interval corresponding to bin Bⱼ. In some embodiments, these measurements may differ and these bins may differ. For example, the measurement corresponding to observation vector 220 could involve a clinical evaluation and the measurement corresponding to Oₖ could involve microarray measurements of gene expression. In some embodiments, computing system 100 may be configured to calculate statistical measures based on the values of joint values matrix 260. For example, computing system 100 may be configured to calculate the joint Shannon entropy for each element of joint values matrix 260.

Referring again to FIG. 2, computing system 100 may be configured to store in memory 110 using processor 105 a data structure including an interleaved component vector 270 in some embodiments. Computing system 100 may be configured to calculate interleaved component vector 270 from joint values matrix 260 in certain aspects. In various aspects, computing system 100 may be configured to receive interleaved component vector 270 through I/O interface 120, or through network adaptor 125. In certain aspects, computing system 100 may be configured to derive interleaved component vector 270 from data received through I/O interface 120, or through network adaptor 125. As shown in FIG. 3G, interleaved component vector 270 may be at least a one-dimensional vector. Interleaved component vector 270 may have columns corresponding to the combination of bin and observation, such as column 372 corresponding to the combination of bin Bⱼ and observation Oₖ Interleaved component vector 270 may include elements, such as element 376 corresponding the combination of bin Bⱼ and observation Oₖ. In certain aspects, these elements may be marginal probabilities. In various aspects, these elements may contain statistical measures based on the values of joint values matrix 260. For example, these elements may contain the sums of the joint Shannon entropies for the columns of joint values matrix 260.

Referring again to FIG. 2, computing system 100 may be configured to store in memory 110 using processor 105 a data structure including statistical output information 280 in some embodiments. Computing system 100 may be configured to calculate statistical output information 280 from interleaved component vector 270 in certain aspects. In certain aspects, computing system 100 may be configured to derive statistical output information 280 from data received through I/O interface 120, or through network adaptor 125. As shown in FIG. 3H, statistical output information 280 may be at least a one dimensional vector. Statistical output information 280 may have columns corresponding to observations, such as column 382 corresponding to observation Oₖ. Statistical output information 280 may correspond to the same observation as observation vector 220. In certain aspects, statistical output information 280 may contain elements, such as element 386, corresponding to (i) the observation that corresponds to observation vector 220 and (ii) the observation Oₖ. These elements may contain values describing the statistical relationship between these observations. For example, these elements may contain the mutual information between (i) the observation that corresponds to observation vector 220 and (ii) the observations corresponding to the columns of observation matrix 210.

The composition of memory 110 as presented in this embodiment is not the only potential embodiment and not intended to be limiting. Some embodiments may not require every disclosed element of memory 110. In certain embodiments, elements of memory 110 may be combined, divided, modified, or absent. Additionally, elements of memory 110 may be stored in one or more physical memories, or represented through a variety of data structures consistent with disclosed embodiments.

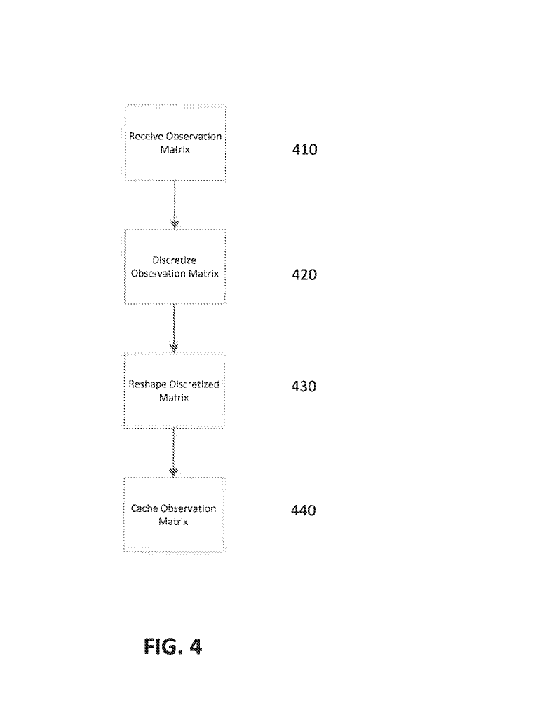

FIG. 4 depicts a flowchart of an exemplary method for pre-calculating cached observation matrix 250 consistent with disclosed embodiments. In step 410, computing system 100 may be configured to receive observations matrix 210. As described above with reference to FIG. 2, observations matrix 210, or data for constructing observations matrix 210, may be received through I/O interface 120 or through network adaptor 125 in various embodiments. Observations matrix may be provided by a user or by a computer system in certain embodiments. For example, observations matrix may be a matrix of patients, corresponding to observations, and genes, corresponding to measurements, with elements of the matrix containing values for gene expression.

Computing system 100 may be configured to bin observations matrix 210 to create discretized observations matrix 230 in step 420. As described above with reference to FIG. 2, the elements of discretized observations matrix 230 may represent the contribution to bins from measurements associated with observations in observations matrix 210. This binning of the measurements may be accomplished using indicator functions or measurement functions to map values for elements of observations matrix 210 to columns of discretized observations matrix 210.

In step 430, computing system 100 may be configured to reshape discretized observations matrix 230 to create, for example, cached observations matrix 250. Reshaping discretized observations matrix 230 may permit computing system 100 to compute joint values matrix 260 as a matrix multiplication using linear algebra subroutines, rather than using computationally expensive loops to iterate through values of the matrix. For example, summing over one two-dimensional matrix with columns corresponding to multiple observations may be more efficient than summing over multiple two-dimensional matrixes, each corresponding to one observation.

In step 440, computing system 100 may be configured to store cached observations matrix 230 in memory 100. Though such caching may increase the memory requirements of the method, this step may offer performance improvements when repeatedly calculating statistical information based on observation matrix 210. For example, a clustering method may determine metagenes corresponding to weighted averages of gene expression. This method may iteratively calculate a distance between an exemplary metagene, corresponding to observation vector 220, and a matrix of observed patterns of gene expression, corresponding to observations matrix 210. In certain aspects, this distance may be a function of the mutual information between the exemplary metagene and the matrix of observed patterns of gene expression. In this example, the improvement in calculating mutual information may outweigh the memory burden of storing the cached observations matrix 230.

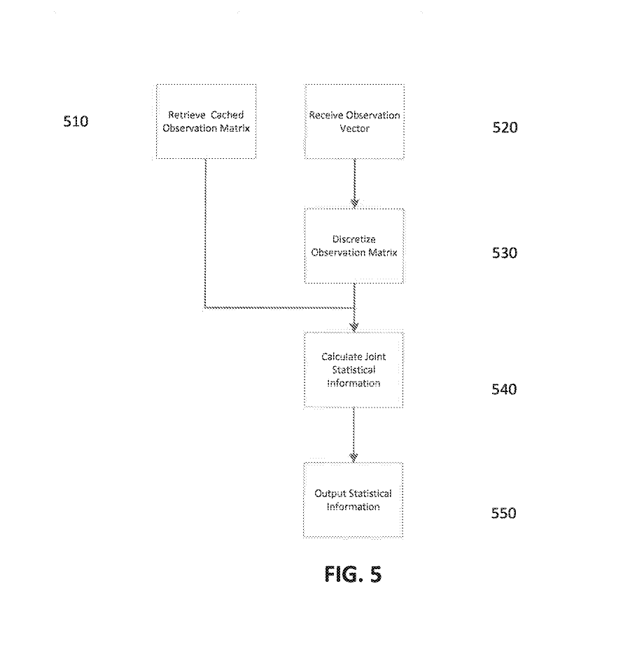

FIG. 5 depicts a flowchart of an exemplary method for determining joint statistical information consistent with disclosed embodiments. Computing system 100 may be configured to retrieve cached observation matrix 250 in step 510 in some embodiments. Cached observation matrix may be stored locally or remotely to computing system 100. In certain aspects, computer system 100 may retrieve cached observation matrix 250 from memory 100, through I/O interface 120, or through network adaptor 125. Computer system 100 may be configured to retrieve observation vector 220 in step 520 consistent with some of the disclosed embodiments. As described with reference to FIG. 2, observation vector 220 may be received through network adaptor 125 or I/O interface 120, or retrieved from memory 110 in certain aspects. In some embodiments, observation vector 220 may correspond to a data structure that is iteratively updated based on the statistical information generated in the previous iteration of the envisioned methods and systems. For example, observation vector 220 may correspond to a metagene associated with weighted average gene expressions. The value of the metagene may be iteratively updated based on a distance between weighted averages of gene expression and a matrix of gene expression measurements corresponding to patients.

Computing system 100 may be configured to bin observation vector 220 to create discretized observation vector 240 in step 530 in certain aspects. As described above with reference to FIG. 2, the elements of discretized observation vector 240 may represent the contribution to bins from measurements associated with observations in observation vector 220. This binning of the measurements may be accomplished using indicator functions or measurement functions to map values for elements of observation vector 220 to columns of discretize observation vector 240.

Computing system 100 may be configured to calculate joint statistical information in step 540 consistent with disclosed embodiments. Computer system 100 may be configured to calculate a double summation of the product of elements of the cached observations matrix 250 and the discretized observation vector 240 in certain aspects. Computer system 100 may be configured to implement this double summation in part as a matrix multiplication of cached observations matrix 250 and discretized observation vector 240. Computer system 100 may be configured to use linear algebra subroutines adapted to efficiently perform matrix multiplication to calculate the joint statistical information. For example, computer system 100 may calculate the joint statistical information between discretized observation vector 240 and cached observations matrix 250 using a call to a low-level kernel subroutine such as a BLAS subroutine. For example, computing system 100 may calculate the joint statistical information using a GEMM subroutine, such as the SGEMM, DGEMM, CGEMM, and ZGEMM subroutines for matrix multiplication at varying precision, or a similar routine known to one of skill in the art. In certain embodiments, computer system 100 may pass discretized observation vector 240, or a transformation or function of this matrix, as an argument to the linear algebra subroutines. In various embodiments, computer system 100 may pass cached observations matrix 250, or a transformation or function of this matrix an argument to the linear algebra subroutines.

Computing system 100 may be configured to output statistical information consistent with disclosed embodiments in step 550. Computing system 100 may output this information, for example, to determine a structure in the set of observations comprising observation matrix 210. For example, this information may be used to identify attractor metagenes defining signatures representing biomolecular events, such as cell transdifferentiation or the presence of an amplicon. In certain aspects, computing system 100 may use processor 105 to output this information through display 115, I/O interface 120, or network adaptor 125.

In some embodiments, the sequence of certain steps depicted in FIG. 5 may be altered. For example, step 510 may be performed before or after either of steps 520 or 530. Likewise, certain steps of the disclose embodiments may be combined, and certain steps may be divided into multiple steps, without departing from the scope of the disclosed embodiments.

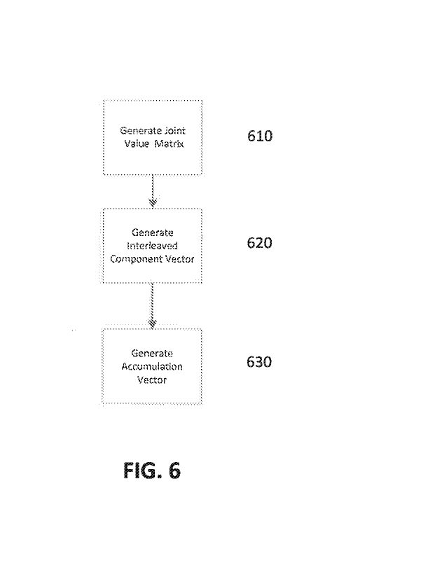

FIG. 6 depicts a flowchart of an exemplary method for calculating statistical information using joint values matrix 260 consistent with disclosed embodiments. In some embodiments, the steps depicted in FIG. 6 may correspond to step 540 of FIG. 5. Consistent with disclosed embodiments, computing system 100 may be configured to generate joint values matrix 260 as described above with reference to FIG. 2 in step 610. In certain aspects, joint values matrix 260 may be based on cached observation matrix 250 and discretized observation vector 240. As described with reference to FIG. 2, joint value matrix 260 may be at least a two dimensional array. Joint value matrix 260 may have rows corresponding to bins for the measurements in observation vector 220 and columns corresponding to bins and observations in observation matrix 210. Computing system 100 may be configured to calculate join value matrix as the matrix product of cached observation matrix 250 and discretized observation vector 240. In certain aspects, computing system 100 may be configured to calculate the joint Shannon entropy associated with each component of joint value matrix 260.

In step 620, computing system 100 may be configured to sum the columns of joint value matrix 260 to generate interleaved component vector 270. As described with reference to FIG. 2, interleaved component vector 270 may be at least a one dimensional vector. Interleaved component vector 270 may have columns corresponding to bins and observations in observation matrix 210. In certain aspects, the elements of interleaved component vector 270 may be margin sums, or functions of the marginal sums, for measurements in observation matrix 210. In other aspects, the elements of interleaved component vector 270 may be components of the joint Shannon entropy associated with each observation in observation matrix 210 and the observation corresponding to observation vector 220. In certain aspects, summing by columns across all observations may reduce execution time for the envisioned method by enabling computing system 100 to call linear algebra subroutines to sum the columns of joint values matrix 260. For example, computing system 100 may call BLAS routines such SSUM to sum the columns of joint values matrix 260.

Computing system 100 may be configured to generate an accumulation vector in step 630 consistent with disclosed embodiments. The accumulation vector may have at least one dimension. The accumulation vector may have columns corresponding to observations in observations matrix 210. Computing system 100 may be configured to generate the accumulation vector from interleaved component vector 270. In certain aspects, computing system 100 may be configured to generate the accumulation vector by reshaping interleaved component vector 270 into a two dimensional vector with columns corresponding to bins and rows corresponding to observations in observations matrix 210. Computing system 100 may be configured to then sum the reshaped vector to generate an accumulation vector with rows corresponding to observations in observations matrix 210. In various aspects, computing system 100 may be configured to iteratively accumulate the entropy associated with each observation into the accumulation vector. Statistical output information 280 may be a function of the accumulation vector. For example, computing system 100 may calculate a first Shannon entropy for the observation in observation vector 220 and second Shannon entropies for the observations in observations matrix 210. Then computing system 100 may calculate the mutual information between the observation in observation vector 220 and the observation in observation matrix 210 as the sum of the first Shannon entropy and the second Shannon entropies, minus the joint Shannon entropies.

In at least one exemplary embodiment, the disclosed methods and systems for calculating statistical information could be used to calculate the mutual information between a first observation and each of a set of second observations. A high-level example of such a method is as follows:
Given Y, a matrix of M measurements for O observations and X, a vector of M measurements for an observation;
Bin all measurements in X and Y and reshape the binned matrix Y into a two-dimensional matrix;
Calculate the quantity XY as X*Y, and normalize this quantity to generate the joint probability distribution XY;
Determine the contributions to the Shannon entropy E for each column of XY;
De-interleave the columns of E to calculate the mutual information between the observation in X and each observation in Y.

The foregoing description of the embodiments has been presented for purposes of illustration only. It is not exhaustive and does not limit the embodiments to the precise form disclosed. Those skilled in the art will appreciate from the foregoing description that modifications and variations are possible in light of the above teachings or may be acquired from practicing the embodiments. For example, though described with reference to continuous random variables, the embodiments may also be applied to calculating joint statistics for discrete random variables. Similarly, as described herein, the terms “row” and “column” are not intended to limit the disclosed embodiments to any particular matrix orientation, as would be recognized by one of skill in the art. Likewise, the steps described need not be performed in the same sequence discussed or with the same degree of separation. Additionally, various steps may be omitted, repeated, or combined, as necessary, to achieve the same or similar objectives. Similarly, the systems described need not necessarily include all parts described in the embodiments, and may also include other parts not describe in the embodiments. Accordingly, the disclosure is not limited to the above-described embodiments, but instead are defined by the appended claims in light of their full scope of equivalents.

What is claimed is:

1. A computer-implemented method, the method comprising,
calling, using a processing device in the computer, a linear algebra subroutine for matrix multiplication with arguments comprising matrices, the matrices comprising:
a first matrix corresponding to a first observation with first elements comprising binned values of first measurements, the rows of the first elements corresponding to first bins and the columns of the first elements corresponding to first measurements, and
a second matrix corresponding to a set of second observations with second elements comprising binned values of second measurements, the rows of the second elements corresponding to second measurements and the columns of the second elements corresponding to second bins and second observations;
receiving, using the processing device of the computer, a joint value matrix from the linear algebra subroutine, the joint value matrix comprising a product of the matrices, with third elements comprising estimated joint probabilities for first bins and second bins; and
outputting, using the processing device of the computer, statistical information based on the joint value matrix to determine a structure for the plurality of second observations.

2. The method of claim 1, further comprising:
determining from the joint value matrix a fourth vector with fourth elements comprising components of joint Shannon entropies associated with the first bins and the second bins.

3. The method of claim 2, further comprising determining from the fourth vector a fifth vector with fifth elements comprising the mutual information between the first observation and the second observations.

4. The method of claim 1, wherein the binned values of first measurements and the binned values of second measurements are determined according to an indicator function.

5. The method of claim 1, wherein the binned values of first measurements and the binned values of second measurements are determined according to a membership function.

6. The method of claim 5, wherein the membership function is a b-splines function.

7. A computer-implemented method, the method comprising,
receiving, using a processing device of the computer, an observation vector corresponding to a first observation, the observation vector including first elements comprising first measurements associated with the first observation;
determining, using the processing device of the computer, a discretized observation vector based on the observation vector, the discretized observation vector including second elements comprising the contribution of first measurements to first bins;
receiving, using the processing device of the computer, a cached observation matrix associated with a plurality of second observations, the cached observation matrix including third elements comprising the contribution of second measurements to second bins;
determining, using the processing device of the computer, a joint value matrix based on the discretized observations matrix and the cached observation matrix, the joint value matrix including fourth elements comprising estimated joint probabilities for first bins and second bins; and
outputting, using the processing device of the computer, statistical information based on the joint value matrix to determine a structure for the plurality of second observations.

8. The method of claim 7, wherein the joint value matrix comprises a product of the discretized observation vector and the cached observation matrix.

9. The method of claim 8, wherein the joint value matrix is determined according to a linear algebra subroutine adapted to efficiently perform matrix multiplication.

10. The method of claim 7, wherein the contribution of first measurements to first bins is determined according to an indicator function.

11. The method of claim 7, wherein the contribution of first measurements to first bins is determined according to a membership function.

12. The method of claim 11, wherein the membership function is a b-splines function.

13. The method of claim 7, further comprising:
determining an interleaved component vector based on the joint value matrix with fifth elements comprising components of joint Shannon entropies associated with the first bins and the second bins.

14. The method of claim 13, further comprising:
determining a statistical output vector based on the interleaved component vector with sixth elements comprising the mutual information between the first observation and the second observations.

15. A non-transitory computer-readable medium comprising instructions that, when executed by at least one processor, cause the at least one processor to perform operations including:
receiving an observation vector corresponding to a first observation, the observation vector including first elements comprising first measurements associated with the first observation;
determining a discretized observation vector based on the observation vector, the discretized observation vector including second elements comprising the contribution of first measurements to first bins;
receiving a cached observation matrix associated with a plurality of second observations, the cached observation matrix including third elements comprising the contribution of second measurements associated with the second observations to second bins;
determining a joint value matrix comprising a product of the discretized observations matrix and the cached observation matrix, the joint value matrix including fourth elements comprising estimated joint probabilities for first bins and second bins;
determining a statistical output vector based on the joint value matrix with fifth elements based on estimated joint probabilities for first bins and second bins, the columns of the fifth vector corresponding to second observations; and
outputting the statistical output vector to determine a structure of the plurality of second observations.

16. The non-transitory computer readable medium of claim 15, wherein the joint value matrix is determined according to a linear algebra subroutine adapted to efficiently perform matrix multiplication.

17. The non-transitory computer readable medium of claim 15, wherein the contribution of first measurements to first bins is determined according to an indicator function.

18. The non-transitory computer readable medium of claim 15, wherein the contribution of first measurements to first bins is determined according to a membership function.

19. The non-transitory computer readable medium of claim 18, wherein the membership function is a b-splines function.

20. The non-transitory computer readable medium of claim 15, wherein the fifth elements comprise the mutual information between the first observation and the second observations.
